(19) United States
(12) Patent Application Publication
(10) Pub. No.: US 2007/0214021 A1
(43) Pub. Date: Sep. 13, 2007

(54) Automated service offering and loss recovery system

(75) Inventor: Sean Francis McLaughlin, Lexington, KY (US)

Correspondence Address: DUKE W. YEE, YEE AND ASSOCIATES, P.C., P.O. BOX 802333, DALLAS, TX, 75380, US

(73) Assignee: International Business Machines Corporation, Armonk, NY (US)

(21) Appl. No.: 11/370,671

(22) Filed: Mar. 7, 2006

(51) Int. Cl. G06Q 40/00

(52) U.S. Cl. 705/4

(57) ABSTRACT

A method and computer instructions for tracking an insurable item is shown. A computer receives a consumer identifier that is uniquely associated with a consumer. The computer also receives a serial number associated with an insurable item from a transponder attached to the insurable item. The computer records to a data structure a purchase by a consumer of the insurable item. The computer presents an offer for insurance to the consumer for the insurable item based on the consumer identifier.

### BACKGROUND OF THE INVENTION

1. Field of the Invention

The present invention relates generally to identification for marketing insurance for products. More specifically, the invention relates to a computer implemented method, apparatus, and computer usable program code for tracking an item before, during and after a purchase.

2. Description of the Related Art

Evolving technologies allow products to be tagged with inexpensive radio frequency transponders and then tracked by devices that can read the information encoded into the radio frequency transponder, which is also referred to as a transponder. Radio frequency identification (“RFID”) uses low-powered radio transmitters to read data stored in a transponder at distances up to 200 feet away. Applications of this technology include tracking assets, managing inventory, automatic vehicle identification, highway toll collection, and authorizing payments.

Developers first made RFID systems in the 1940s. An initial application of the technology allowed the U.S. government to use transponders to distinguish between friendly and enemy aircraft. Air traffic controllers continue to use transponders for aircraft tracking. In addition to tracking aircraft, the commercial aviation industry has used RFID tags to route baggage and increase air security. In the 1970s, the U.S. government used RFID systems for tracking livestock and nuclear material. Recent applications allow a vendor to authenticate customers in order to pay for food or gas.

Commercial applications generally operate in unlicensed frequency bands, with 125 KHz and 13.56 MHz being the most common. The greater the bandwidth the more information a RFID tag can hold. For instance, a 13.56 MHZ tag can hold as much as 2,000 bits of data, roughly 30 times the information that may be transmitted using a 125 KHz tag. Active RFID tags are equipped with a battery that allows an active tag to transmit a signal to a reader. These tags often provide the greatest range, up to 200 feet, but are more expensive than other tags. Passive RFID tags are not battery powered. Instead, this type of device draws power from the electromagnetic waves emitted from the receiver-transmitter or RFID reader. The read range of these tags is generally under three meters. Semi-passive RFID tags have batteries like active RFID tags, but the battery is only used to power the tag's microchip circuitry. Semi-passive tags also have longer read ranges than passive tags.

One example of RFID use is inventory control, wherein items include attached RFIDs. Up to 2,000 bits of data are stored on a memory chip constructed in a button or integrated circuit card. Some tags include etching on a substrate, embedded in a paper or plastic tag. The information stored on the tag may include a unique product identification code, the place of product manufacture, and the place of sale. The tag may include a battery or it may be passive.

A RFID transmitter-receiver or reader generally includes a transmitter, a receiver and a digital control module connected to a transmitting antenna. The reader interrogates RFIDs, receives a response, and decodes the data. The reader passes that data on to a host system. The host system assimilates the data received from the product tags. The host system often provides reports used to track product inventory and sales.

Air traffic controllers routinely assign transponder codes to identify aircraft. More recently, motorists assign unique codes to their cars to assist in toll-way billing. Such codes would be helpful as well, if they were available to the insurance and police agencies with respect to expensive theft-prone items. The current system involving a user filling in a warranty card and mailing the card to a manufacturer only associates a minority of purchasers with uniquely identifiable items.

### SUMMARY OF THE INVENTION

The present invention provides a method, apparatus and computer instructions for tracking an insurable item. A data processing system receives a consumer identifier that is uniquely associated with a consumer. The data processing system also receives a serial number associated with an insurable item from a transponder attached to the insurable item. The data processing system records to a data structure a purchase by a consumer of the insurable item. The data processing system presents an offer for insurance to the consumer for the insurable item based on the consumer identifier.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows a block diagram of a radio frequency reader system in accordance with an illustrative embodiment of the present invention;

FIG. 2 shows a typical placement of a radio frequency reader system in accordance with an illustrative embodiment of the present invention;

FIG. 3 shows a network diagram in accordance with an illustrative embodiment of the present invention;

FIG. 4 shows an exemplary record stored in an insurer repository in accordance with an illustrative embodiment of the present invention;

FIG. 5 shows a Radio Frequency Identifier (RFID) tag in operation connected to an insurable item in accordance with an illustrative embodiment of the present invention;

FIG. 6 shows a radio frequency identifier tag in communication with a radio frequency reader in accordance with an illustrative embodiment of the present invention;

FIG. 7 shows a flowchart of steps to offer insurance and other services in accordance with an illustrative embodiment of the present invention;

FIG. 8 shows a block diagram of devices that communicate when a consumer suffers a loss in accordance with an illustrative embodiment of the present invention; and

FIG. 9 shows a flowchart of steps to handle a loss in relation to an insured item in accordance with an illustrative embodiment of the present invention.

### DETAILED DESCRIPTION OF THE PREFERRED EMBODIMENT

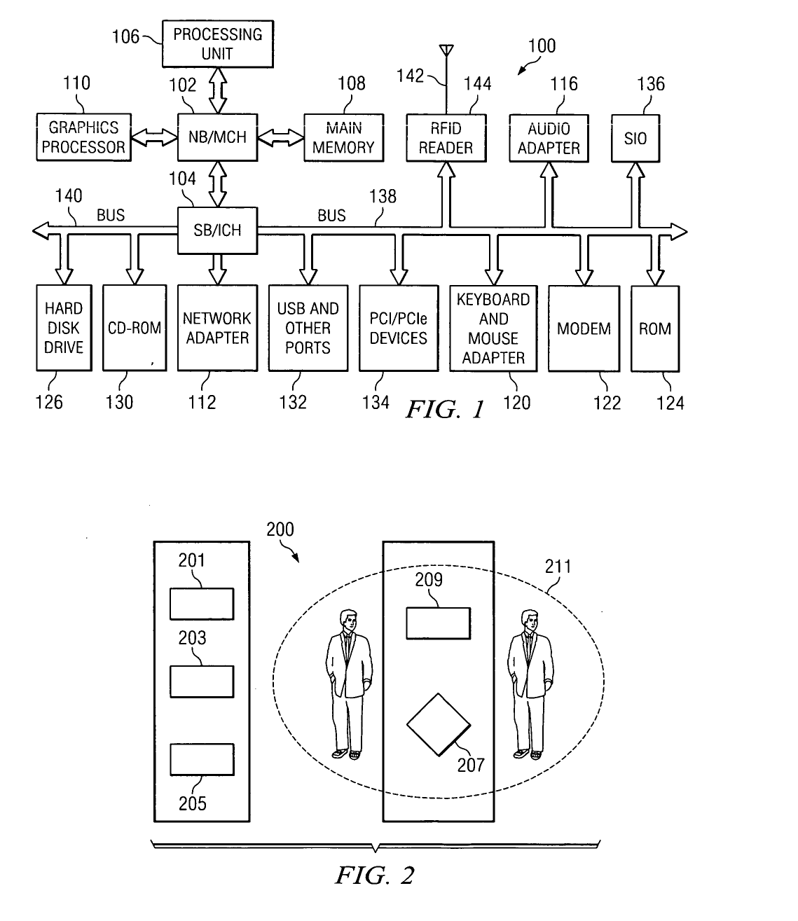

With reference now to the figures and in particular with reference to FIG. 1, a block diagram of a data processing system is shown in which embodiments of the present invention may be implemented. In the depicted example, data processing system 100 employs a hub architecture including north bridge and memory controller hub (MCH) 102 and south bridge and input/output (I/O) controller hub (ICH) 104. Processing unit 106, main memory 108, and graphics processor 110 connect to north bridge and memory controller hub 102. Graphics processor 110 may connect to north bridge and memory controller hub 102 through an accelerated graphics port (AGP).

In the depicted example, local area network (LAN) adapter 112, audio adapter 116, keyboard and mouse adapter 120, modem 122, read only memory (ROM) 124, universal serial bus (USB) ports and other communications ports 132, and PCI/PCIe devices 134 connect to south bridge and I/O controller hub 104 through bus 138. PCI/PCIe devices may include, for example, Ethernet adapters, add-in cards, and PC cards for notebook computers. PCI uses a card bus controller, while PCIe does not. ROM 124 may be, for example, a flash binary input/output system (BIOS).

Hard disk drive 126 and CD-ROM drive 130 connect to south bridge and I/O controller hub 104 through bus 140. Hard disk drive 126 and CD-ROM drive 130 may use, for example, an integrated drive electronics (IDE) or serial advanced technology attachment (SATA) interface. Super I/O (SIO) device 136 may be connected to south bridge and I/O controller hub 104.

In addition, radio frequency identifier (RFID) reader 144 connects to bus 138 and may be controlled through bus 138. Radio frequency identifier reader 144 may comprise a reader transmitter for transmitting an interrogate signal and a reader receiver receiving a radio frequency response corresponding to the interrogate signal. Such signals may pass via antenna 142 into and out from radio frequency reader 144. In operation, bus 138 and devices attached thereto may operate as a controller in relation to the operation of radio frequency identifier reader 144.

An operating system runs on processing unit 106 and coordinates and controls various components within data processing system 100 in FIG. 1. The operating system may be a commercially available operating system, such as Advanced Interactive executive (AIX®), which is available from IBM Corporation. AIX is a registered trademark of IBM Corporation. Specialty software may operate on data processing system 100. The specialty software includes instructions for data processing system 100 to carry out the steps of the illustrative embodiments of the present invention. The specialty software, operating in conjunction with the operating system on a data processing system, may collectively be referred to as the process.

Embodiments of the present invention permit an insurer to present insurance to a consumer for an item. The embodiments of the present invention describe how to capitalize on unique identifiers, available wirelessly, such that the user may obtain insurance and the insurer has an accurate description of the item insured. In addition, should the consumer desire to skip insurance, a data processing system records details of the transaction so that a consumer may positively identify a lost item to an agency, such as, a police department.

FIG. 2 shows a typical placement of a radio frequency reader system in accordance with an illustrative embodiment of the present invention. FIG. 2 shows a store 200 having an inventory of insurable items, for example stereo amplifiers 201-205. An insurable item is any tangible item to which a transponder is attached. A consumer may select stereo amplifier 207 for purchase. Stereo amplifier 207 has a transponder, for example, a radio frequency identifier tag.

A transponder is a device that receives a radio signal, and converts the signal to a responsive signal with which the transponder responds. The responsive signal includes information identifying the transponder. One form of a transponder is a transponder in an aircraft. The transponder permits a pilot to adjust the identifying code of the aircraft with hand controls. The aircraft transponder, unlike transponders commonly used for car toll-tags, is powered so that the transponder may be read from a distance measured in miles. The transponder has an embedded serial number that uniquely identifies the insurable item, for example, a universally unique identifier (UUID). For a transponder intended only for reading, the circuit may be formed into a flat package that resembles a label and has an adhesive surface. The adhesive surface is applied to a product in order to attach the transponder. For applications where the transponder is intended to discourage thieves, the transponder may be attached to a hidden surface of a product.

The consumer brings stereo amplifier 207 to a point-of-sale station at a check-out area of a store. In these examples, the check-out area generally conforms to the effective communication radius 211 of point-of-sale station 209. Point-of-sale station 209 is a data processing system, for example data processing system 100 of FIG. 1. Data processing system 100 may execute many of the steps of the illustrative embodiments of the present invention. Many point-of-sale stations include a drawer for keeping cash and other payment instruments.

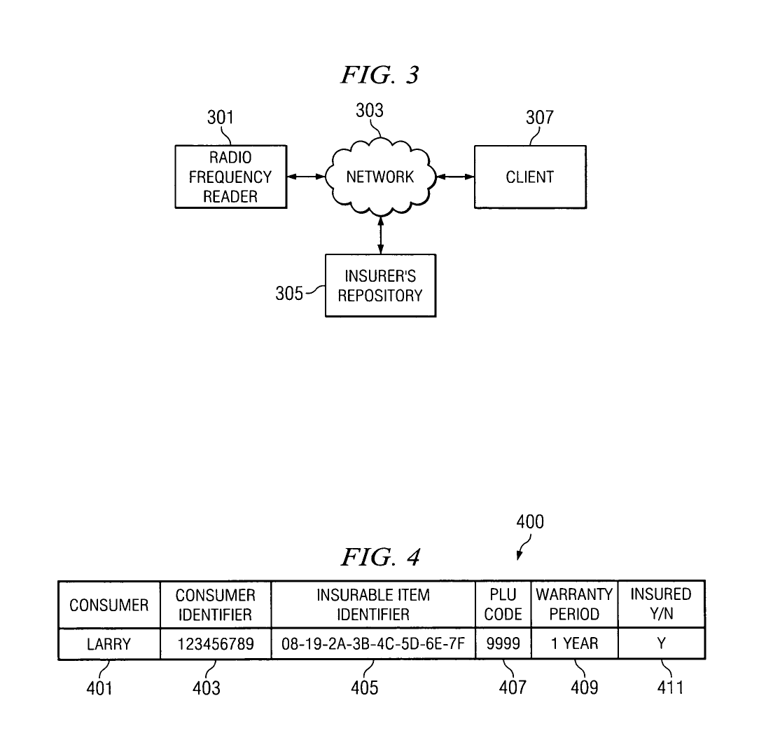

FIG. 3 shows a network diagram in accordance with an illustrative embodiment of the present invention. Radio frequency reader 301 communicates via network 303 to insurer repository 305. In this example, insurer repository 305 is a data center that stores information in a reliable, non-volatile manner. The repository may store data on storage devices such as, for example, hard disk drives. Insurer repository 305 collects information for creating records and permits an owner or operator to read, update, delete and search the record. Further, insurer repository 305 keeps records of a consumer's activities, for example a history of purchases and demographics.

In addition, insurer repository 305 may keep records of durability, obsolescence and other matters concerning the insurable item. Such records may permit a better estimation of risks associated with a particular consumer as related to a particular class of insurable items. In addition, insurer's repository 305 may include a negotiation history. A negotiation history is records concerning offers made to a consumer, as well as offers accepted and offers declined by the consumer.

Insurer repository 305 indexes records based on a consumer identifier. A consumer identifier identifies a consumer in a unique manner as compared to all consumers stored to insurer repository 305. In its simplest form, a consumer identifier may be a social security number. If a consumer is a business or another social entity, the consumer identifier may be an employer identification number. Alternatively, consumer identifiers may be issued as serial numbers from an insurer, for example, stored within identification cards. An identification card is any portable medium designed to identify uniquely the consumer with a consumer identifier stored in the identification card. Portable media includes identification cards bearing magnetic strips, and smart cards. Identification cards may have sufficient storage capacity to permit a data structure to be organized, for example, an array of records that may include in a record, a serial number, a purchase date, and an indication of an insurer's agreement to insure. A radio frequency identifier reader may read a radio frequency identifier embedded on a smart card.

FIG. 4 shows an exemplary record 400 in an insurer repository. A record comprises customer name 401, consumer identifier 403, insurable item identifier 405, please-look-up code 407, warranty period 409, and indicator of insurance 411. Warranty period 409 may be a period of time that the manufacturer offers labor and repair for an item. As such, warranty period 409 denotes how durable the item is.

It is appreciated that the record of FIG. 4 may vary in the kinds of data recorded, and may include records in a varying form. FIG. 4 shows such a record merely as an example. An insurer repository may index the records based on insurable item identifier 407, which may be a serial number associated with an insurable item. Additional record types may correlate, for example, a consumer identifier with an electronic mail address, suitable for receiving offers of insurance. An electronic mail address is an address associated with a user in an electronic communication system. Electronic mail addresses include those used for email, short text messages, and instant messaging, among others.

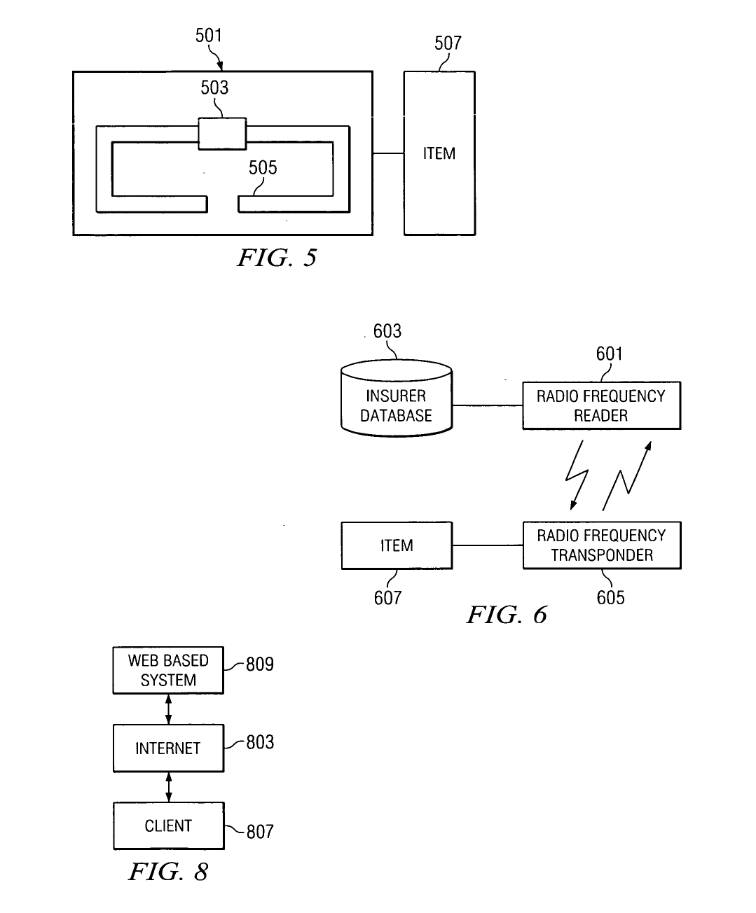

FIG. 5 shows radio frequency identifier (RFID) tag 501 in operation connected to an insurable item in accordance with an illustrative embodiment of the present invention. Insurable item 507 may be, for example, stereo amplifier 207 as shown in FIG. 2. Radio frequency identifier tag 501 may be attached to an outer surface of insurable item 507. For insurable items that do not substantially shield radio frequency signals, radio frequency tag 501 may be attached inside of insurable item 507. In this illustrative example, insurable item 507 includes antenna 505, coupled to circuit 503. Circuit 503 may be an integrated circuit. Circuit 503 may permit writing information to an internal memory in a non-volatile fashion. Antenna 505 may operate to receive interrogation signals. In addition, antenna 505 may transmit response signals. Such response signals may encode a serial number, for example, a universally unique identifier.

FIG. 6 shows a radio frequency identifier tag in communication with a radio frequency reader in accordance with an illustrative embodiment of the present invention. For example, given the scenario of FIG. 2, a consumer may bring insurable item 607 within range of radio frequency reader 601. Radio frequency reader 601 transmits interrogate signal 611 periodically. If insurable item 607 is positioned such that radio frequency transponder 605 is within a range that radio frequency transponder 605 is detectable, then radio frequency reader 601 receives and decodes response 613. Radio frequency reader 601 transmits a message to insurer repository 603 that includes the serial number decoded from response 613.

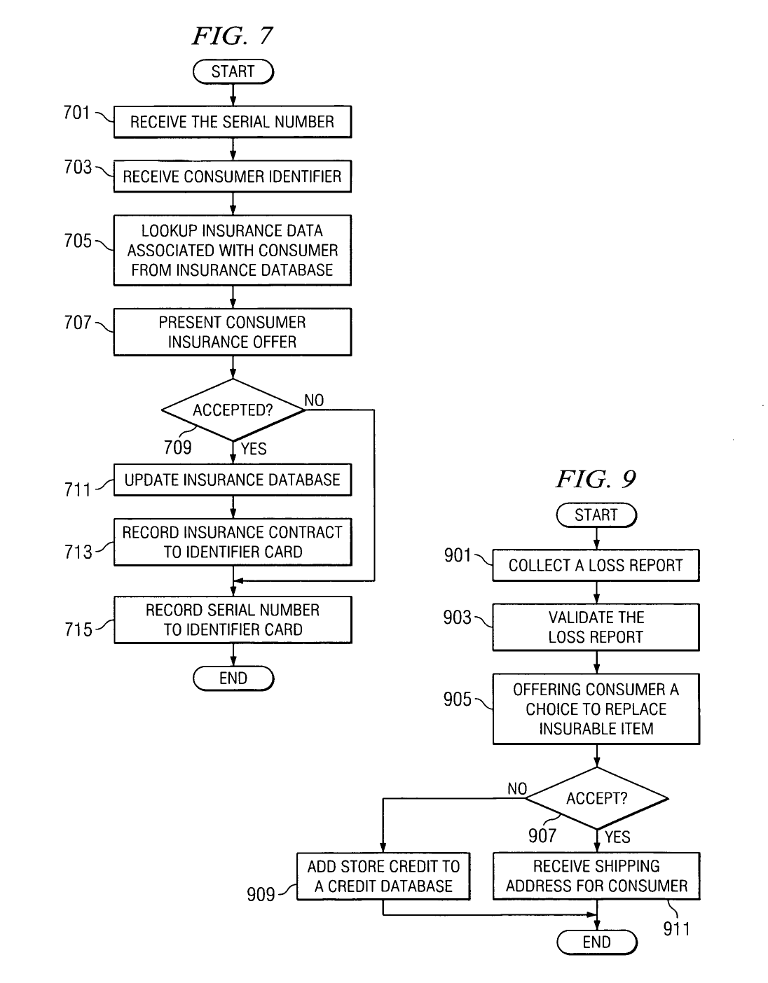

FIG. 7 shows a flowchart of steps to offer insurance and other services in accordance with an illustrative embodiment of the present invention. Steps in FIG. 7 may occur intermingled with steps to account for items presented for purchase and receiving a consumer's written or other act of agreeing to purchase the insurable item. Alternatively, the steps in FIG. 7 may occur some distance from the point of sale, for example, at a second location where a user presents a claim ticket to a retailer's pick-up location. In addition, the consumer may receive and respond to actions of the process from a client computer, for example, client 307 of FIG. 3. The steps of FIG. 7 are presented in the former example of a purchase intermingled with FIG. 7 steps.

The process in FIG. 7 may be implemented in a data processing system, such as, for example, data processing system 100 in FIG. 1. Accordingly, the process operates on data processing system 100. The steps may be performed within a store, for example by point-of-sale station 209 of FIG. 2 under the control of the data processing system. Initially, a consumer presents an insurable item for purchase. The radio frequency reader, under process control, receives the serial number (step 701). The process receives a consumer identifier (step 703). In the event the consumer does not have a consumer identifier, the process may assign a consumer identifier to the consumer. For example, a consumer identifier is written to an identifier card kept by a store attendant. The attendant gives the identifier card to the consumer, wherein the identifier card may carry a radio frequency identifier. In most cases, however, the process receives the consumer identifier through an interrogate/response typical of reading a radio frequency identifier. Alternatively, until radio frequency identifiers are common in identification cards of the consumer, the consumer identifier may be a home telephone number or other number suited to identify the consumer uniquely. The consumer may be a cohabitating couple, or a family unit. The process looks up insurance data associated with the consumer from an insurer repository (step 705). Responsive to looking-up, the process may receive information concerning a consumer known or otherwise recorded to the insurer repository. Alternatively, the process may receive an indication that the insurer repository has not yet recorded the consumer. In the latter case, the process may assign an identification card a unique consumer identifier, so that the consumer may be tracked thereafter, wherein the identification card is responsive, now, to the process.

Based on information concerning the consumer or the absence of such information, the process presents the consumer with an offer to insure the at least one item presented in step 701 (step 707). An offer for insurance is an offer to insure also known as an insurance offer. Because information concerning the consumer may indicate that the consumer resides in a high crime neighborhood, the process may adjust the offer to insure to set a higher premium or a shorter duration of insurance than would otherwise be offered. An offer to insure is written or spoken terms that include one or more of the following terms presented: 1) the item to be insured; 2) the consumer; 3) a premium cost; 4) the insuring party; and 5) a duration of coverage, including perpetual or lifetime. In particular, the premium cost may appear as a line item or transaction total to which a consumer approves with a credit card, debit card, or the equivalent. The full terms of an offer to insure may supplement the one or more terms presented. The full terms of an offer to insure may appear in a preprinted form or other detailed offer display. An offer to insure may also include terms such as limitations and exclusions, for example, that coverage ends once a second sale occurs, or that renting or intentional neglect may cancel insurance coverage. Other terms consistent with offering insurance may also be included in the offer to insure the insurable item.

Presenting may be, in the exemplary process of FIG. 1, displaying terms on a monitor coupled to graphics processor 110. Presenting may include spoken terms issued from a speaker connected to audio adapter 116. The presenting step may also occur multiple times, and remote from the initial point of sale. For example, dispatching an electronic communication to a consumer wherein the consumer provides a processing system. In this example, the process presents by video, sound, or touch, the terms to the consumer in a manner perceptible to the consumer. An electronic communication is a communication transmitted through wired and/or wireless media, for example electronic mail.

The process determinates whether the consumer has accepted the insurance offer or offer to insure (step 709). Determining acceptance involves receiving at data processing system 100 one or more please-look-up (PLU) codes. A please-look-up code is a code that uniquely identifies an offer form's terms, which may include open fields or blanks that are specific to the consumer, and/or insurable item. A retailer may have dozens of standard terms associated with various classes of offers to insure. Usually, there is one please-look-up code for each class of offer to insure. A person may enter the code at a keyboard. In addition, a person may scan with a bar code reader, or enter in any other manner customary for a point-of-sale terminal. A determination of acceptance is positive if, for example, a please-look-up code is received that matches a code of a class of insurance offers. If any other code is received, or an indication of a completed transaction is received, then a determination of acceptance is negative. Acceptance is any code or electronic message that indicates the consumer has accepted the insurance offer. An indication of a completed transaction is an input that indicates that the customer is satisfied to purchase only the items presented without any add-on service.

Alternatively, step 709 may occur following the actual purchase of the insurable item. Acceptance takes the form of a received electronic communication wherein the consumer accepts the last insurance offer sent to him.

Based on a positive determination at step 709, the process updates an insurance repository with the L particulars of the contract (step 711). A contract is the terms of the last offer made to a consumer, wherein the consumer has accepted the terms. Particulars are the terms of the last offer made, in this context. Such particulars may be recorded in abbreviated or summary form. Particulars may include, for example premium cost, and duration of coverage, which may be implicitly associated with a please-look-up code that identifies the insurance offer and the contract. Updating may include the process transmitting the particulars to an insurance repository, and optionally may include an acknowledgement back from the insurance repository.

The process stores an insurance contract in the identification card (step 713). The insurance contract includes particulars up to, but not including the serial number of the insurable item. The process records the serial number to the identification card (step 715). Step 715 occurs following a negative determination at step 709. Consequently, regardless of consumer acceptance of the offer to insure, the process executes step 715. The process terminates thereafter.

One or more additional steps of presenting an offer to insure may follow, provided a consumer does not choose to accept at step 709. A “decline” is an input or message received by the process that indicates that a consumer does not accept the offer most recently made. An insurable item may have a warranty period having an established warranty end based on the purchase date of the insurable item. The process may persist with additional electronic communications to the consumer that have additional offers. The terms of each offer may be based on any known negotiating history associated with the consumer. Consequently, the process may look up a negotiating history based on the consumer identifier. The process may store any subsequent acceptances or declines to the negotiating history.

A helpful time to make offers is shortly before a warranty end. The process calculates the warranty end based on the manufacturer's warranty associated with the insured item and the purchase date. A warranty end is the time that a manufacturer establishes to assure customers of product quality, and yet limit the residual costs of customer care. An offer made ten days prior to the warranty end is close enough to the end to convey a sense of urgency to the consumer, yet early enough to allow that the consumer may be on vacation or otherwise occupied.

FIG. 8 shows a client interaction with a web-based system in accordance with an illustrative embodiment of the present invention. Such an interaction occurs when a consumer suffers an insurable loss with respect to the insurable item. Consumer operates a client 807, which is software that operates on, for example, data processing system 100 of FIG. 1. Client 807 connects via internet 803 to connect to web-based system 801, which may be, for example, another instance of data processing system 100 of FIG. 1. A web-based system is a data processing system, an operating system and a process, wherein the data processing system operates with an operating system. Alternatively, the web-based system may comprise the components of data processing system 100, except not including or requiring radio frequency reader 144.

FIG. 9 shows a flowchart of a process for handling a loss of an insured item in accordance with an illustrative embodiment of the present invention. The steps of FIG. 8 are performed, for example, by web-based system 801 of FIG. 8. A user, having previously established insurance for an insured item, suffers an insurable loss in relation to the insured item. For example, a thief may have stolen the insured item. A user may login to the web-based system to create a loss report. A loss report is a report that identifies the consumer and the insured item. A loss report may include details that identify a supplemental report made to a police agency. In that case, the loss report may identify the police agency and a report number. A report number may be a unique number assigned by the police agency to assist and establish statistics, criminal patterns, and solve crimes.

It is appreciated that a web-based system is used for exemplary purposes, and that information may also be collected by an interactive voice response system. The web-based system collects the loss report (step 901). The web-based system validates the loss report (step 903). For example, the web-based system may confirm that there is no conflicting loss report that uses the same report number. Other validation may include confirming that the consumer has satisfied all conditions to collect under the terms of an applicable offer to insure. The web-based system may offer the consumer a choice to replace the insurable item (step 905). The web-based system may send the offer in hypertext transfer protocol to a client computer operated by the client. The web-based system may receive an acceptance (step 907). Acceptance may occur when a client computer sends a response generated upon a consumer entering a field according to a criteria or clicking on a button according to a criteria.

If the consumer accepts and the web-based system receives the acceptance, the web-based system adds a store credit to a credit database (step 909). Credit database is a data structure within the logical insurer database, for example, insurer database 603 of FIG. 3. Credit database may be any conventional accounting system used for billing and crediting customer's accounts. A store credit is a rational number measured in units of currency, which may be added to an account balance. If, however, the web-based system does not receive acceptance, the web-based system may query the consumer for a shipping address. The web-based system receives the shipping address for the consumer (step 911). The process ends thereafter.

Thus, the aspects of the present invention provide a computer implemented method, apparatus, and computer usable program code to facilitate offering insurance for products using radio frequency identification tags. The embodiments of the present invention describe how to capitalize on unique identifiers, available wirelessly, such that the user may obtain insurance and the insurer has an accurate description of the item insured. In addition, should the consumer desire to skip insurance, a data processing system records details of the transaction so that a consumer may positively identify a lost item to an agency, such as, a police department.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for offering insurance comprising:
receiving an identifier from a transponder associated with an insurable item, wherein the identifier uniquely identifies the insurable item;
associating the identifier with a consumer; and
presenting an offer for insurance for the insurable item to the consumer.

2. The computer implemented method of claim 1, wherein associating comprises:
recording the identifier with the consumer identifier in an insurer repository.

3. The computer implemented method of claim 1, wherein presenting comprises:
recording a purchase wherein the identifier is recorded on an identification card provided to the consumer at a point-of-sale station; and
offering insurance to the consumer for the item recorded on the identification card.

4. The computer implemented method of claim 1, wherein associating comprises:
storing the identifier to an identification card.

5. The computer implemented method of claim 1 further comprising:
transmitting the consumer identifier to an insurer repository; and
receiving at least one term of service of the offer from the insurer repository.

6. The computer implemented method of claim 1, wherein offering comprises:
presenting at least one term of service.

7. The computer implemented method of claim 6, wherein presenting comprises:
dispatching an electronic communication to an electronic mail address associated with the consumer.

8. A computer implemented method for determining a loss associated with an insurable item comprising:
receiving a consumer identifier;
receiving a serial number;
sending an electronic communication having an offer;
receiving an acceptance; and
collecting a loss report.

9. The computer implemented method of claim 8, wherein collecting further comprises:
validating the loss report.

10. The computer implemented method of claim 8 further comprising:
offering a consumer a choice between replacing the insurable item or receiving a store credit; and
receiving a consumer choice.

11. The computer implemented method of claim 8 further comprising:
determining whether the consumer choice is a store credit; and
adding the store credit to a credit database.

12. The computer implemented method of claim 8 further comprising:
looking up a manufacturers warranty expiration period;
calculating a warranty end; and
sending an electronic message offer comprises transmitting an electronic message offer near the warranty end.

13. The computer implemented method of claim 8, wherein transmitting an email offer near the warranty end comprises:
sending the electronic message offer within ten days of the warranty end.

14. A computer program product comprising a computer usable medium having computer usable program code for offering insurance, the computer program product including;
computer usable program code for receiving an identifier from a transponder associated with an insurable item, wherein the identifier uniquely identifies the insurable item;
computer usable program code for associating the identifier with a consumer; and
computer usable program code for presenting an offer for insurance for the insurable item to the consumer.

15. The computer program product of claim 14, wherein computer usable code for associating comprises:
computer usable program code for recording the identifier with the consumer identifier in an insurer repository.

16. The computer program product of claim 14, wherein computer usable code for presenting comprises:
computer usable program code for recording a purchase wherein the identifier is recorded on an identification card provided to the consumer at a point-of-sale station; and
computer usable program code for offering insurance to the consumer for the item recorded on the identification card.

17. The computer program product of claim 14, wherein computer usable code for associating comprises:
computer usable program code for storing the identifier to an identification card.

18. The computer program product of claim 14 further comprising:
computer usable program code for transmitting the consumer identifier to an insurer repository; and
computer usable program code for receiving at least one term of service of the offer from the insurer repository.

19. The computer program product of claim 14, wherein computer usable code for offering comprises:
computer usable program code for presenting at least one term of service.

20. The computer program product of claim 14, wherein computer usable code for presenting comprises:
computer usable program code for dispatching an electronic communication to an electronic mail address associated with the consumer.
